(19) United States
(12) Patent Application Publication
(10) Pub. No.: US 2007/0075940 A1
(43) Pub. Date: Apr. 5, 2007

(54) ORGANIC EL DISPLAY AND METHOD OF DRIVING THE SAME

(76) Inventor: Norio NAKAMURA, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/537,946

(22) Filed: Oct. 2, 2006

(30) Foreign Application Priority Data
Oct. 5, 2005 (JP) 2005-292590

(51) Int. Cl. G09G 3/30

(52) U.S. Cl. 345/77

(57) ABSTRACT

An active matrix organic EL display includes pixels each including a pixel circuit and an organic EL element connected in series between first and second power supply terminals in this order, a temperature sensor sensing a temperature or temperature change of the organic EL element, and a power supply circuit applying a voltage between the first and second power supply terminals. The display changes a potential of the second power supply terminal such that an absolute value of the voltage between the first and second power supply terminals is decreased when the temperature sensor senses a temperature rise.

### CROSS-REFERENCE TO RELATED APPLICATIONS

This application is based upon and claims the benefit of priority from prior Japanese Patent Application No. 2005-292590, filed Oct. 5, 2005, the entire contents of which are incorporated herein by reference.

### BACKGROUND OF THE INVENTION

1. Field of the Invention

The present invention relates to a display and a method of driving the same, and particularly, to an active matrix organic electroluminescent (herein after to be referred to as “EL”) display and a method of driving the same.

2. Description of the Related Art

Some organic EL displays regulate brightness of a pixel by controlling magnitude of a drive current flowing through an organic EL element. Specifically, the brightness of the pixel becomes higher by increasing the magnitude of the drive current.

The lifetime of an organic EL element used under high temperature conditions is shorter than that used under low temperature conditions. Since an organic EL display generates heat, the lifetime of an organic EL element can be improved by suppressing the heat generation of the organic EL display.

### BRIEF SUMMARY OF THE INVENTION

According to a first aspect of the present invention, there is provided an active matrix organic EL display, comprising pixels each including a pixel circuit and an organic EL element connected in series between first and second power supply terminals in this order, a temperature sensor sensing a temperature or temperature change of the organic EL element, and a power supply circuit applying a voltage between the first and second power supply terminals, wherein the display is configured to change a potential of the second power supply terminal such that an absolute value of the voltage between the first and second power supply terminals is decreased when the temperature sensor senses a temperature rise.

According to a second aspect of the present invention, there is provided an active matrix organic EL display, comprising pixels each including a drive transistor and an organic EL element connected in series between first and second power supply terminals, the drive transistor comprising a gate whose potential is to be set based on magnitude of current to be fed through the organic EL element, and the display being configured to change voltage between the first and second power supply terminals according to a temperature change of the organic EL element.

According to a third aspect of the present invention, there is provided a method of driving an active matrix organic EL display comprising pixels each including a pixel circuit and an organic EL element connected in series between first and second power supply terminals in this order, and a temperature sensor sensing a temperature or temperature change of the organic EL element, comprising changing a potential of the second power supply terminal such that an absolute value of the voltage between the first and second power supply terminals is decreased when the temperature sensor senses a temperature rise.

### BRIEF DESCRIPTION OF THE SEVERAL VIEWS OF THE DRAWING

FIG. 1 is a perspective view schematically showing an active matrix organic EL display according to an embodiment of the present invention;

FIG. 2 is a plan view schematically showing an example of circuit configurations that can be employed in the array substrate of the display shown in FIG. 1;

FIG. 3 is an equivalent circuit diagram of the pixel included in the array substrate shown in FIG. 2;

FIG. 4 is a sectional view schematically showing an example of structures that can be employed in the array substrate shown in FIG. 2;

FIG. 5 is a timing chart illustrating a method of driving an organic EL display employing the circuit configuration shown in FIG. 2;

FIG. 6 is a plot of an example of current-voltage characteristics that an organic EL element exhibits under low temperature conditions;

FIG. 7 is a plot of an example of current-voltage characteristics that an organic EL element exhibits under intermediate temperature conditions;

FIG. 8 is a plot of an example of current-voltage characteristics that an organic EL element exhibits under high temperature conditions;

FIG. 9 is an equivalent circuit diagram of a power supply circuit that can be used in the organic EL display shown in FIG. 1;

FIG. 10 is a plot of an example of temperature-resistance characteristics of a thermistor; and

FIG. 11 is a plot illustrating a relationship between temperature and potential of a power supply terminal.

### DETAILED DESCRIPTION OF THE INVENTION

An embodiment of the present invention will be described below in detail with reference to the drawings. In the drawings, components having the same or similar function are denoted by the same reference symbol and duplicate descriptions will be omitted.

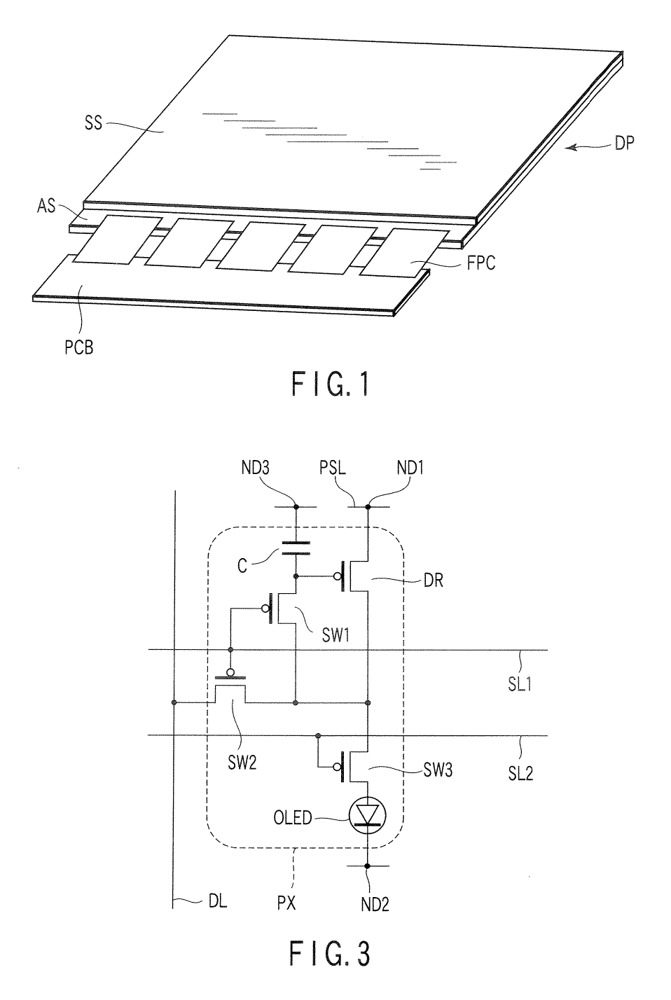

FIG. 1 is a perspective view schematically showing an active matrix organic EL display according to an embodiment of the present invention.

The organic EL display includes an organic EL display panel DP, a printed circuit board PCB, and flexible printed circuits FPC. In addition, the display includes a temperature sensor sensing a temperature or temperature change of organic EL elements as described later.

The organic EL display panel DP includes an array substrate AS. As an example, a sealing substrate SS is placed to face the surface of the array substrate on which organic EL elements are formed, and an adhesive layer is interposed between the peripheries of the array substrate AS and the sealing substrate SS.

Each flexible printed circuit FPC electrically connects the array substrate AS and the printed circuit board PCB. On the printed circuit board PCB, a power supply circuit and a circuit for driving a scan signal line driver and a video signal line driver are mounted.

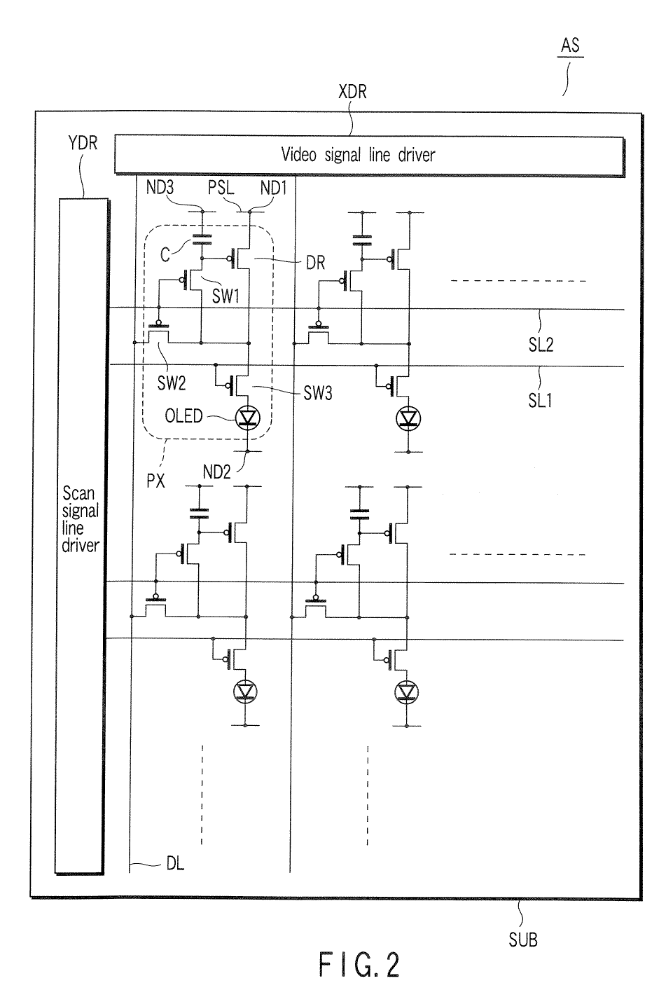

FIG. 2 is a plan view schematically showing an example of circuit configurations that can be employed in the array substrate of the display shown in FIG. 1. FIG. 3 is an equivalent circuit diagram of the pixel included in the array substrate shown in FIG. 2.

The array substrate AS includes pixels PX. The pixels PX are arranged in a matrix on an insulating substrate SUB such as glass substrate.

A scan signal line driver YDR and a video signal line driver XDR are placed on the substrate SUB.

On the substrate SUB, scan signal lines SL1 and SL2 connected to the scan signal line driver YDR run along the rows of the pixels PX. The scan signal line driver YDR supplies scan signals as voltage signals to the scan signal lines SL1 and SL2.

Further, on the substrate SUB, video signal lines DL connected to the video signal line driver XDR run along the columns of the pixels PX. The video signal line driver XDR supplies video signals to the video signal lines DL.

In addition, on the substrate SUB, power supply lines PSL are placed.

Each pixel PX includes a pixel circuit and an organic EL element OLED as a display element. The pixel circuit includes a drive control element DR, a diode-connecting switch SW1, a selector switch SW2, an output control switch SW3, and a capacitor C.

The organic EL element OLED includes an anode, a cathode facing the anode, and an organic layer whose optical characteristic changes in accordance with magnitude of current flowing between the anode and the cathode. As an example, the anode is a bottom electrode, and the cathode is a top electrode facing the bottom electrode with the organic layer interposed therebetween.

The drive control element DR is, for example, a drive transistor. The drive transistor is, for example, a thin-film transistor (herein after referred to as “TFT”) whose source and drain are formed in a polycrystalline semiconductor layer. As an example, the drive control element DR is a p-channel TFT including a polycrystalline silicon layer as the polycrystalline semiconductor layer. The source of the drive control element DR is connected to the power supply line PSL. Note that the node ND1 on the power supply line PSL is a first power supply terminal.

The diode-connecting switch SW1 is connected between the drain and gate of the drive control element DR. The switching operation of the diode-connecting switch SW1 is controlled, for example, by the scan signal supplied from the scan signal line driver YDR via the scan signal line SL2. The diode-connecting switch SW1 is, for example, a switching transistor. As an example, the diode-connecting switch SW1 is a p-channel TFT whose gate is connected to the scan signal line SL2.

The selector switch SW2 is a video signal supply control switch. The selector switch SW2 is connected between the drain of the drive control element DR and the video signal line DL. The selector switch SW2 is, for example, a switching transistor. As an example, the selector switch SW2 is a p-channel TFT whose gate is connected to the scan signal line SL2.

The output control switch SW3 and the display element OLED are connected in series between the drain of the drive control element DR and a second power supply terminal DN2. The output control switch SW3 is, for example, a switching transistor. As an example, the output control switch SW3 is a p-channel TFT whose gate, source and drain are connected to the scan signal line SL1, the drain of the drive control element DR, and the anode of the display element OLED, respectively.

The capacitor C includes an electrode connected to the gate of the drive control element DR. The capacitor C keeps the potential of the gate of the drive control element DR almost constant during the display period following the write period. As an example, the capacitor C is connected between a constant-potential terminal ND3 and the gate of the drive control element DR.

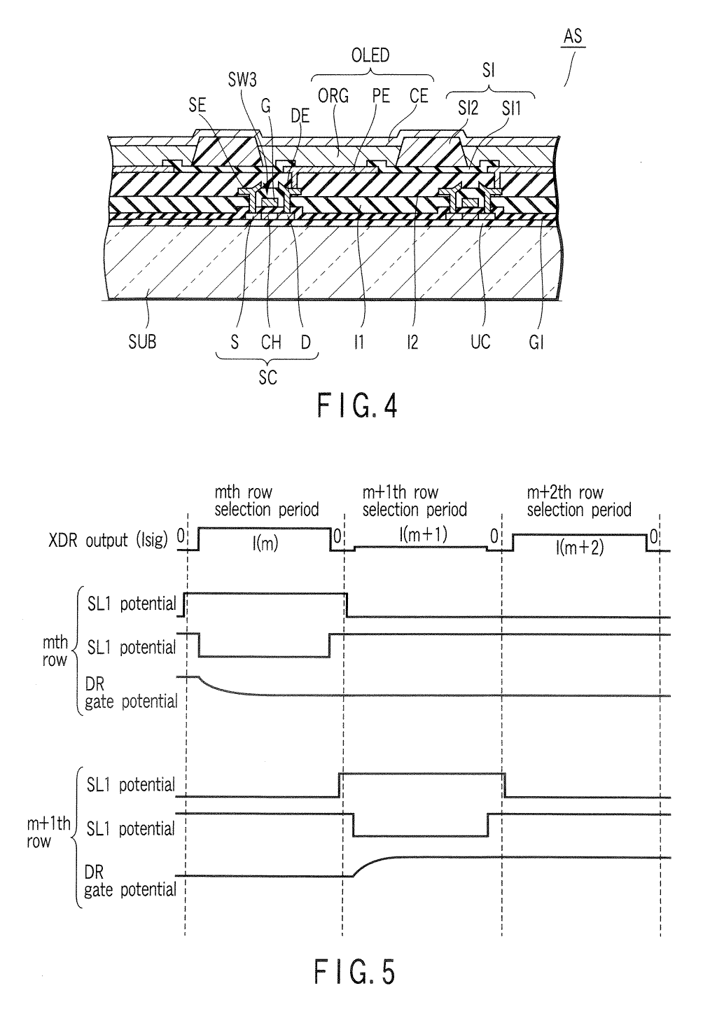

FIG. 4 is a sectional view schematically showing an example of structures that can be employed in the array substrate shown in FIG. 2. In FIG. 4, only the output control switch SW3 is shown as the TFTs. The diode-connecting switch SW1 and the selector switch SW2 have the same structure as that of the output control switch SW3, and the drive control element DR has the similar structure as that of the output control switch SW3.

As shown in FIG. 4, a main surface of the insulating substrate SUB is covered with an undercoat layer UC. The undercoat layer UC is, for example, a laminate of a silicon nitride layer and a silicon oxide layer.

On the undercoat layer UC, a patterned polysilicon layer is placed as semiconductor layers SC. In each semiconductor layer SC, the source S and the drain D of TFT is formed to be spaced apart from each other. The region of the semiconductor layer SC between the source S and the drain D is used as the channel.

A gate insulator GI is formed on the semiconductor layers SC, and a first conductor pattern and an insulating film II are sequentially formed on the gate insulator GI. The first conductor pattern is utilized as the gates of the TFTs, first electrodes (not shown) of the capacitors C, the scan signal lines SL1 and SL2, interconnections connecting them together. The insulating film I1 is utilized as an interlayer insulating film and dielectric layers of the capacitors C.

On the insulating film I1, a second conductor pattern is formed. The second conductor pattern is utilized as source electrodes SE, drain electrodes DE, second electrodes (not shown) of the capacitors C, the video signal lines DL, the power supply lines PSL, and interconnections connecting them together. The source electrodes SE and the drain electrodes DE are connected to the sources S and drains D of the TFTs at positions of through-holes formed in the insulating film GI and I1.

On the second conductor pattern and the insulating film I1, an insulating film I2 and a third conductor pattern is formed sequentially. The insulating film I2 is utilized as a passivation film and/or a planarizing layer. The third conductor pattern is utilized as pixel electrodes of the organic EL elements OLED. As an example, the pixel electrodes PE are anodes.

In the insulating film I2, through-holes communicating to the source electrodes SE connected to the sources S of the output control switches SW3 are formed correspondently with the pixels PX. Each pixel electrode PE covers the sidewall and the bottom of the through-hole so as to be electrically connected to the source S of the output control switch SW3 via the source electrode SE.

On the insulating film I2, a partitioning insulation layer SI is formed. As an example, the partitioning insulation layer SI is formed of an inorganic insulating layer SI1 and an organic insulating layer SI2. The inorganic insulating layer SI1 may be omitted.

In the partitioning insulation layer SI, through-holes are formed at positions of the pixel electrodes PE. In each through-hole of the partitioning insulation layer SI, the organic layer ORG including an emitting layer covers the pixel electrode PE. The emitting layer is, for example, a thin film containing a luminescent organic compound that emits red, green, or blue light. In addition to the emitting layer, each organic layer ORG may include a hole injection layer, a hole transporting layer, an electron transporting layer, and an electron injection layer. Each layer included in the organic layer can be formed, for example, by evaporation using a mask or inkjet method.

On the partitioning insulation layer SI and the organic layers ORG, a counter electrode CE is formed. The counter electrode CE is a common electrode shared among the pixels PX. The counter electrode CE is electrically connected to the electrode wire via a contact hole formed in the insulating films I1 and I2 and the partitioning insulation layer SI. As an example, the counter electrode CE is the cathode.

Each organic EL element OLED is composed of the pixel electrode PE, organic layer ORG, and counter electrode CE.

FIG. 5 is a timing chart illustrating a method of driving an organic EL display employing the circuit configuration shown in FIG. 2.

In FIG. 5, the abscissa denotes time, while the ordinate denotes potential or magnitude of current. In FIG. 5, the waveform indicated as “XDR output (I_{sig})” shows current that the video signal line driver XDR makes flow through the video signal line DL, the waveforms indicated as “SL1 potential” and “SL2 potential” show potentials of the scan signal lines SL1 and SL2, respectively, and the waveforms indicated as “DR1 gate potential” and “DR2 gate potential” show the gate potential of the drive control element DR.

According to the method shown in FIG. 5, the organic EL display employing the circuit configuration shown in FIG. 2 is driven as follows.

When a certain gray level is to be displayed on a pixel PX in the m th row, during a period over which the pixels PX in the m th row are selected, that is, an m th row selection period, the potential of the scan signal line SL1 is changed from a second potential to a first potential higher than the second potential so as to open the output control switch SW3. During a write period over which the output control switch SW3 is open, the write operation described below is executed.

First, the potential of the scan signal line SL2 is changed, for example, from the first potential to the second potential so as to close the diode-connecting switch SW1 and the selector switch SW2. Thus, the drain and gate of the drive control element DR and the video signal line DL are connected to one another.

In this state, a video signal is supplied from the video signal line driver XDR via the video signal line DL to the selected pixel PX. That is, the video signal line driver XDR makes a current I_{sig} flow from the power supply terminal ND1 to the video signal line DL. Magnitude of the current I_{sig} corresponds to magnitude of the drive current to be supplied to the display element OLED of the selected pixel PX, that is, the gray level to be displayed on the selected pixel PX.

This write operation sets the gate-to-source voltage of the drive control element DR at a value when the current I_{sig} flows between the gate and drain of the drive control element DR.

Note that the source potential of the drive control element DR is equal to the potential of the first power supply terminal ND1. That is, the source potential of the drive control element DR is constant during whole the period including the write period over which the output control switch SW3 is open and the effective display period over which the output control switch SW3 is closed. Therefore, setting the gate-to-source voltage of the drive control element DR by the write operation means setting the gate potential of the drive control element DR at the voltage V_{g} corresponding the magnitude of the current I_{sig}. Next, the potential of the scan signal line SL2 is changed, for example, from the second potential to the first potential so as to open the diode-connecting switch SW1 and the selector switch SW2. That is, the drain and gate of the drive control element DR and the video signal line DL are disconnected from one another. Subsequently, in this state, the potential of the scan signal line SL1 is changed, for example, from the first potential to the second potential so as to close the output control switch SW3.

As described above, by the write operation, the gate potential of the drive control element DR is set at the value V_{g} when the current I_{sig} flows. The gate potential is kept at the value V_{g} until the diode-connecting switch SW1 and the selector switch SW2 are closed. Therefore, during the effective display period, the drive control element DR regulates the magnitude of the drive current flowing through the display element OLED at a value corresponding to the magnitude of the current I_{sig}. Consequently, the display element OLED displays the gray level corresponding to the magnitude of the drive current.

The organic EL display includes the temperature sensor sensing temperature or temperature change of the organic EL elements OLED as described above. The power supply circuit applying voltage between the first power supply terminal ND1 and the second power supply terminal ND2, which is mounted to the printed circuit board PCB in this embodiment, changes the potential of the second power supply terminal ND2 such that the absolute value of the voltage between the first power supply terminal ND1 and the second power supply terminal ND2 is decreased when the temperature sensor senses the temperature rise. Such a control makes it possible to suppress the heat generation by the organic EL display without adversely affecting the visual quality.

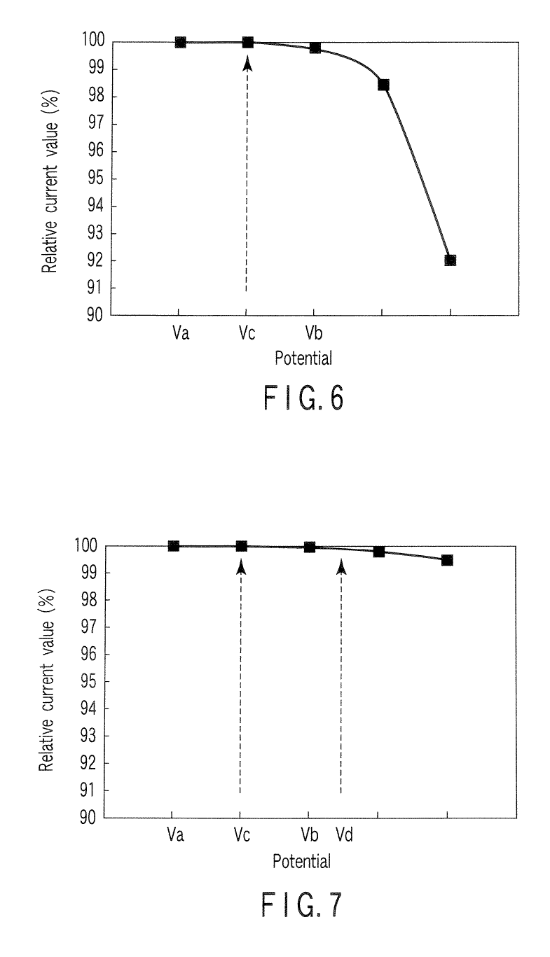

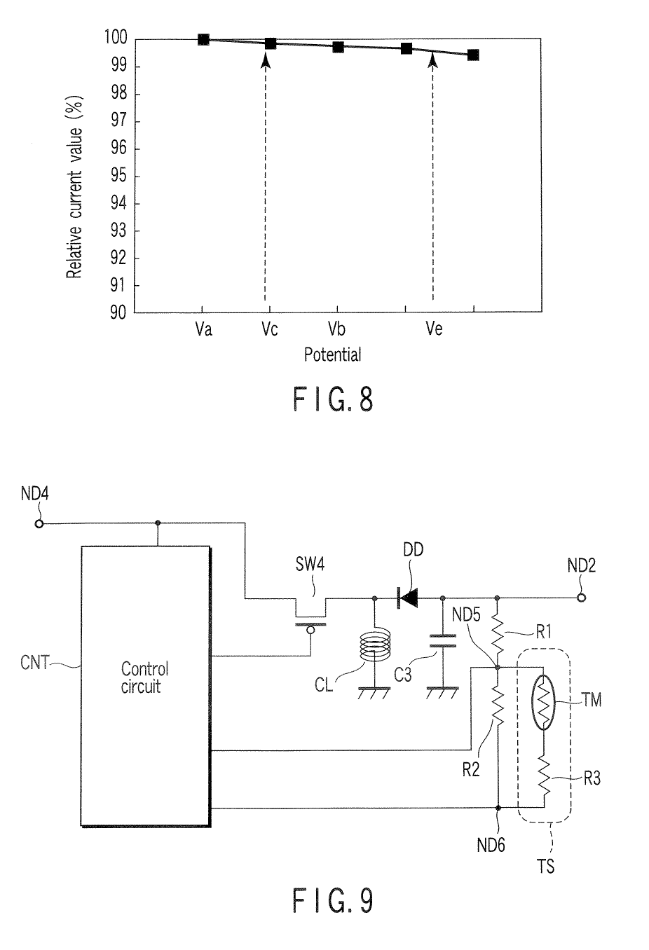

FIGS. 6 to 8 are plots of examples of current-voltage characteristics that an organic EL element exhibits under a low temperature condition, an intermediate temperature condition, and a high temperature condition, respectively. In the figures, the abscissa denotes the potential of the cathode CE of the organic EL element OLED, while the ordinate denotes the relative current value, which is a ratio of magnitude of current flowing through the organic EL element OLED with respect to magnitude of current flowing through the organic EL element OLED when the potential of the cathode CE is set at a potential Vₐ. Note that the potential of the anode PE of the organic EL element OLED is kept constant.

As shown in FIGS. 6 to 8, when the potential of the cathode CE is equal to or lower than the potential V_{b}, the magnitude of the current flowing through the organic EL element OLED is almost equal to that in the case where the potential of the cathode CE is set at the potential Vₐ regardless of whether the temperature condition is the low temperature condition, the intermediate temperature condition, or the high temperature condition. Therefore, when the potential of the second power supply terminal ND2 is set at a potential higher than the potential Vₐ and equal to or lower than the potential V_{b}, for example, the potential V_{c}, the voltage applied across the organic EL element OLED can be decreased as compared to the case where the potential of the second power supply terminal ND2 is set at the potential Vₐ. In addition, almost the same visual quality as in the case where the potential of the second power supply terminal ND2 is set at the potential Vₐ can be achieved. However, if the potential of the second power supply terminal ND2 were to be fixed to the potential V_{c} an excessively high voltage would be applied across the organic EL element OLED under the intermediate temperature condition or the high temperature condition.

When the voltage applied across the organic EL element OLED is made higher, the power consumption and the heat generation of the organic EL element OLED increase. Further, the lifetime of the organic EL element OLED used under high temperature conditions is shorter than that used under low temperature conditions.

In the present embodiment, the potential of the second power supply terminal ND2 is changed in response to the temperature rise of the organic EL element OLED such that the absolute value of the voltage between the first power supply terminal ND1 and the second power supply terminal ND2 is decreased. Since the potential of the second power supply terminal ND2 is set lower than that of the first power supply terminal ND1 in this example, the potential of the second power supply terminal ND2 is raised in response to the temperature rise of the organic EL element OLED so as to lower the voltage between the first power supply terminal ND1 and the second power supply terminal DN2. For example, the potential V_{d} of the second power supply terminal under the intermediate temperature condition is set higher than the potential V_{c} by about 1.5 V, and the potential Vₑ of the second power supply terminal ND2 under the high temperature condition is set higher than the potential V_{c} by about 2.5 V.

In this case, it is possible to prevent an excessively high voltage to be applied across the organic EL element OLED regardless of whether the temperature condition is the low temperature condition, the intermediate temperature condition, or the high temperature condition. Thus, the heat generation of the organic EL element OLED can be decreased as compared with the case where the potential of the second power supply terminal ND2 is fixed to the potential V_{c}. Therefore, by executing the potential control described above, it is possible to lower the temperature of the organic EL element OLED and achieve a longer lifetime as compared with the case where the potential of the second power supply terminal ND2 is fixed to the potential V_{c}.

Since the potential control makes it possible to prevent an excessively high voltage to be applied across the organic EL element OLED regardless of the temperature conditions, the power consumption of the organic EL element OLED can be decreased as compared with the case where the potential of the second power supply terminal ND2 is fixed to the potential V_{c}. In addition, similar to the case where the potential of the second power supply terminal ND2 is fixed to the potential V_{c}, almost the same visual quality as in the case where the potential of the second power supply terminal ND2 is set at the potential Vₐ can be achieved.

The potential control described above can be performed, for example, by employing the following configuration in the power supply circuit.

FIG. 9 is an equivalent circuit diagram of a power supply circuit that can be used in the organic EL display shown in FIG. 1. Note that only a part of the power supply circuit is shown in FIG. 9. Specifically, only the configuration for controlling the potential of the second power supply terminal ND2 is shown in FIG. 9.

The power supply circuit shown in FIG. 9 includes a control circuit CNT. A power supply terminal ND4 that supplies a constant potential higher than the potential of the second power supply terminal ND2 is connected to the control circuit CNT.

A diode DD and a switch SW4 are connected in series between the power supply terminals ND2 and ND4 in this order. The forward direction of the diode DD is the same as the direction of current flowing from the power supply terminal ND2 to the diode DD. As an example, the switch SW4 is a p-channel TFT whose gate is connected to the control circuit CNT.

An end of a coil CL is connected to the drain of the switch SW4. Another end of the coil CL is grounded, for example.

An electrode of a capacitor C3 is connected to the power supply terminal DN2. Another end of the capacitor C3 is grounded, for example.

A resistance element R1 is connected between a power supply terminal ND5 and a node ND6. A resistance element R2 and a temperature sensor TS are connected in parallel between the node ND5 and a node ND6. In this example, the temperature sensor TS includes a thermistor TM and a resistance element R3 connected in series between the nodes ND5 and ND6.

The nodes ND5 and ND6 are connected to the control circuit CNT. The node ND6 is kept at a constant potential lower than the potential of the power supply terminal ND2 and the reference potential V_{reg} described later.

In the circuit shown in FIG. 9, the control circuit CNT opens and closes the switch SW4 at regular intervals. The control circuit CNT compares a feedback potential V_{fb} as the potential of the node ND5 with the reference potential V_{reg} lower than the potential of the power supply terminal ND2, and controls a ratio of the period over which the switch SW4 is open with respect to the period over which the switch SW4 is closed based on the result of the comparison.

Specifically, when the feedback potential V_{fb} is higher than the reference potential V_{reg}, the period over which the switch SW4 is closed is shortened. On the other hand, when the feedback potential V_{fb} is lower than the reference potential V_{reg}, the period over which the switch SW4 is closed is elongated.

When the period over which the switch SW4 is closed is shortened, the potential of the power supply terminal ND2 and the feedback potential V_{fb} are lowered. On the other hand, when the period over which the switch SW4 is closed is elongated, the potential of the power supply terminal ND2 and the feedback potential V_{fb} are raised.

Thus, under the condition that temperature is kept constant, the circuit shown in FIG. 9 keeps the feedback potential V_{fb} at a value almost equal to the reference potential V_{reg}. That is, under the condition that temperature is kept constant, the circuit shown in FIG. 9 keeps the potential of the power supply terminal ND2 at a constant potential corresponding to the reference potential V_{reg}.

The difference between the potential V_{nd2} of the power supply terminal ND2 and the potential V_{nd6} of the node ND6 can be represented by the following equation, where V_{nd5} (=V_{reg}=V_{fb}) is the potential of the node ND5, R₁ is the resistance of the resistance element R1, R₂ is the resistance of the resistance element R2, and Rₜₛ is the resistance of the temperature sensor TS.

$${V}_{nd 2} - {V}_{nd 6} = \frac{{R}_{1} \times {R}_{2} + {R}_{2} \times {R}_{ts} + {R}_{ts} \times {R}_{1}}{{R}_{2} \times {R}_{ts}} \times ( {V}_{nd 5} - {V}_{nd 6} )$$

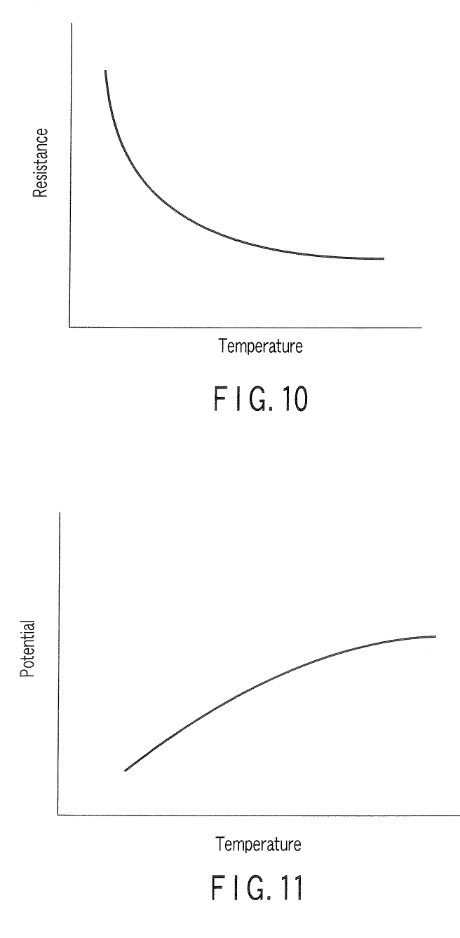

FIG. 10 is a plot of an example of temperature-resistance characteristics of the thermistor TM. FIG. 11 is a plot illustrating a relationship between temperature and the potential of the power supply terminal DN2. In FIG. 10, the abscissa denotes temperature, while the ordinate denotes resistance of the thermistor TM. In FIG. 11, the abscissa denotes temperature, while the ordinate denotes the potential V_{nd2} of the power supply terminal DN2.

As shown in FIG. 10, the resistance of the thermistor TM varies according to the temperature. Specifically, when the temperature is raised, the resistance of the thermistor TM is increased.

The resistance Rₜₛ of the temperature sensor TS is equal to the sum of the resistance of the resistance element R3 and the resistance of the thermistor TM. Therefore, when the resistance of the thermistor TM is increased with the temperature rise, the resistance Rₜₛ of the temperature sensor TS is increased, too.

The potential V_{nds} of the node ND5, i.e., the feedback potential V_{fb} is controlled to be equal to the reference potential V_{reg}. The potential V_{nd6} of the node ND6 is constant and is lower than the reference potential V_{reg}. That is, the difference between the potential V_{nd5} of the node ND5 and the potential V_{nd6} of the node ND6 is a positive constant value.

Therefore, as apparent from the above equation, when the resistance Rₜₛ is decreased with the temperature rise, the difference between the potential V_{nd2} of the power supply terminal ND2 and the potential V_{nd6} of the node ND6 increases. That is, the potential V_{nd2} of the power supply terminal ND2 is raised with the temperature rise.

By such a method, the circuit shown in FIG. 9 raises the potential V_{nd2} of the power supply terminal ND2 when the temperature is raised, and lowers the potential V_{nd2} of the power supply terminal ND2 when the temperature is lowered.

In the example shown in FIG. 9, the relationship between the temperature change and the potential change of the power supply terminal ND2 can be changed according to the temperature coefficient of resistance of the thermistor TM or each resistance of the resistance elements R1 to R3, for example.

In the example shown in FIG. 9, three resistance elements R1 to R3 are used. The resistance element R2 and/or the resistance element R3 may be omitted.

In the example shown in FIG. 9, the temperature sensor TS includes the thermistor TM and the resistance element R3. The temperature sensor TS may have other structures. For example, a TFT including a polycrystalline silicon layer may be used as the temperature sensor TS. The magnitude of leakage current flowing through a TFT varies according to temperature. Therefore, in this case, the same control as that using the thermistor TM can be performed.

As long as the temperature sensor TS can sense the temperature of the organic EL element OLED, the temperature sensor TS may be placed anywhere. For example, the temperature sensor TS may be placed on the array substrate AS, the sealing substrate SS, or printed circuit board PCB. Alternatively, the temperature sensor TS may be placed to be spaced apart from the display panel DP, the printed circuit board PCB, etc. such that the temperature sensor TS senses the ambient temperature.

In the above embodiment, the pixel circuit employs the configuration shown in FIG. 3. The pixel circuit may have other configurations as long as it can control the magnitude of the drive current correspondently with the magnitude of the video signal. For example, a configuration utilizing a voltage signal as the video signal, which is to be supplied from the video signal line DL to the pixel circuit, may be employed in the pixel circuit instead of employing the configuration utilizing a current signal as the video signal.

In the above embodiment, the potential of the power supply terminal ND1 is set higher than that of the power supply terminal DN2. Alternatively, the potential of the power supply terminal ND2 may be set higher than that of the power supply terminal ND1. In this case, the cathode and anode of the organic EL element OLED may be connected to the pixel circuit and the power supply terminal ND2, respectively.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An active matrix organic EL display, comprising:
pixels each including a pixel circuit and an organic EL element connected in series between first and second power supply terminals in this order;
a temperature sensor sensing a temperature or temperature change of the organic EL element; and
a power supply circuit applying a voltage between the first and second power supply terminals,
wherein the display is configured to change a potential of the second power supply terminal such that an absolute value of the voltage between the first and second power supply terminals is decreased when the temperature sensor senses a temperature rise.

2. The display according to claim 1, wherein the temperature sensor includes a thermistor.

3. The display according to claim 1, wherein the power supply circuit includes a control circuit configured to keep each potential of first and second constant-potential terminals constant, a first resistance element connected between the first power supply terminal and the first constant-potential terminal, and a second resistance element connected between the and second constant-potential terminals, and wherein the temperature sensor includes a thermistor and a third resistance element connected in series between the first and second constant-potential terminals.

4. The display according to claim 1, further comprising video signal lines arranged correspondently with columns of the pixels, wherein the pixel circuit includes a drive transistor and first to third switches, a source of the drive transistor being connected to the first power supply terminal, the first switch being connected between drain and gate of the drive transistor, the second switch being connected between the drain of the drive transistor and the video signal line, and the third switch and the organic EL element being connected in series between the drain of the drive transistor and the second power supply terminal.

5. The display according to claim 1, wherein the power supply circuit is configured to change a potential of the second power supply terminal such that an absolute value of the voltage between the first and second power supply terminals is decreased when the temperature sensor senses a temperature rise.

6. The display according to claim 5, wherein the temperature sensor includes a thermistor.

7. The display according to claim 5, wherein the power supply circuit includes a control circuit configured to keep each potential of first and second constant-potential terminals constant, a first resistance element connected between the first power supply terminal and the first constant-potential terminal, and a second resistance element connected between the and second constant-potential terminals, and wherein the temperature sensor includes a thermistor and a third resistance element connected in series between the first and second constant-potential terminals.

8. The display according to claim 5, further comprising video signal lines arranged correspondently with columns of the pixels, wherein the pixel circuit includes a drive transistor and first to third switches, a source of the drive transistor being connected to the first power supply terminal, the first switch being connected between drain and gate of the drive transistor, the second switch being connected between the drain of the drive transistor and the video signal line, and the third switch and the organic EL element being connected in series between the drain of the drive transistor and the second power supply terminal.

9. An active matrix organic EL display, comprising pixels each including a drive transistor and an organic EL element connected in series between first and second power supply terminals, the drive transistor comprising a gate whose potential is to be set based on magnitude of current to be fed through the organic EL element, and the display being configured to change voltage between the first and second power supply terminals according to a temperature change of the organic EL element.

10. A method of driving an active matrix organic EL display comprising pixels each including a pixel circuit and an organic EL element connected in series between first and second power supply terminals in this order, and a temperature sensor sensing a temperature or temperature change of the organic EL element, comprising:
changing a potential of the second power supply terminal such that an absolute value of the voltage between the first and second power supply terminals is decreased when the temperature sensor senses a temperature rise.
